(19) United States
(12) Patent Application Publication
(10) Pub. No.: US 2013/0258675 A1
(43) Pub. Date: Oct. 3, 2013

(54) LIGHT-EMITTING STRUCTURE

(71) Applicants: Shang-Jung Wu, Taipei (TW); Kun-Huang Hsu, Taipei (TW); Chien-Chuan Chen, Taipei (TW)

(72) Inventors: Shang-Jung Wu, Taipei (TW); Kun-Huang Hsu, Taipei (TW); Chien-Chuan Chen, Taipei (TW)

(73) Assignee: INHON INTERNATIONAL CO. LTD., Taipei (TW)

(21) Appl. No.: 13/612,418

(22) Filed: Sep. 12, 2012

(30) Foreign Application Priority Data
Apr. 3, 2012 (TW) 101206080

(51) Int. Cl. F21V 13/02

(52) U.S. Cl. 362/307

(57) ABSTRACT

A light-emitting structure includes a shell, a light-transmissive body, a light-shading layer, a patterned layer, and a light-source module. The light-transmissive body is embedded in the shell and the light-transmissive body includes an incident surface, an emergence surface, a first reflective surface and a second reflective surface. The light-shading layer is adhered on the first reflective surface. The patterned layer is adhered on the second reflective surface, and the patterned layer is revealed at the emergence surface. The light-source module is disposed in the vicinity of the incident surface, when the light-source module emits light, the light enters the light-transmissive body from the incident surface, the light reflects to the second reflective surface from the first reflective surface. Then, the light reflects to the emergence surface from the second reflective surface before emits out of the light-transmissive body.

### CROSS-REFERENCE TO RELATED APPLICATIONS

This non-provisional application claims priority under 35 U.S.C. §119(a) on Patent Application No(s). 101206080 filed in Taiwan, R.O.C. on Apr. 3, 2012, the entire contents of which are hereby incorporated by reference.

### BACKGROUND

1. Technical Field The present disclosure relates to a light-emitting structure, and more particularly to a light-emitting structure applicable to a mark of an electronic device.

2. Related Art

Lately, manufacturing technologies of electronic products are improved with development of information technology. In addition to a compact design, the electronic products are also developed towards superior performance and modern-looking design.

Take laptop as an example, in order to increase unique selling points of the laptop, each manufacturer changes a brand mark on the laptop from a simple printing display into an illuminating display. Furthermore, the brand mark with the illuminating display is that by forming an opening on a shell of the laptop, a display light source may be emitted out of the opening. Moreover, a light-transmissive plate showing the brand mark is disposed on the opening so that the brand mark has an illuminating effect.

In detail, the brand mark consists of a combination of a light-transmissive area and a light-shading area. For example, the shape of the light-transmissive area corresponds to the shape of the brand mark, that is, the illuminating area represents the mark. However, under the light-transmissive plate is the display light source, so the light-transmissive area just shows the light-transmitting only. Thus, it is an innovative visual way to show the brand marks.

### SUMMARY

An embodiment of the disclosure provides a light-emitting structure comprising a shell, a light-transmissive body, a light-shading layer, a patterned layer and a light-source module. The light-transmissive body is embedded in the shell and the light-transmissive body comprises an incident surface, an emergence surface, a first reflective surface and a second reflective surface. The light-shading layer is adhered on the first reflective surface. The patterned layer is adhered on the second reflective surface, and the patterned layer is revealed at the emergence surface. The light-source module is disposed in the vicinity of the incident surface. When the light-source module emits light, the light enters the light-transmissive body from the incident surface, and the light is reflected to the second reflective surface from the first reflective surface. Then the light is reflected to the emergence surface from the second reflective surface before emits out of the light-transmissive body.

### BRIEF DESCRIPTION OF THE DRAWINGS

The present disclosure will become more fully understood from the detailed description given herein below for illustration only, and thus are not limitative of the present disclosure, and wherein:

FIG. 1 is a schematic view of a light-emitting structure applicable to an electronic device according to an embodiment;

FIG. 2 is a cutaway view of a light-emitting structure along line 2-2 in FIG. 1;

FIG. 3 is a cutaway view of a light-emitting structure according to another embodiment; and

FIG. 4 is a cutaway view of a light-emitting structure according to another embodiment.

### DETAILED DESCRIPTION

The detailed features and advantages of the disclosure are described below in great detail through the following embodiments, the content of the detailed description is sufficient for those skilled in the art to understand the technical content of the present disclosure and to implement the disclosure there accordingly. Based upon the content of the specification, the claims, and the drawings, those skilled in the art can easily understand the relevant objectives and advantages of the disclosure.

The disclosure discloses a light-emitting structure enhancing an illuminating effect showed from a brand mark.

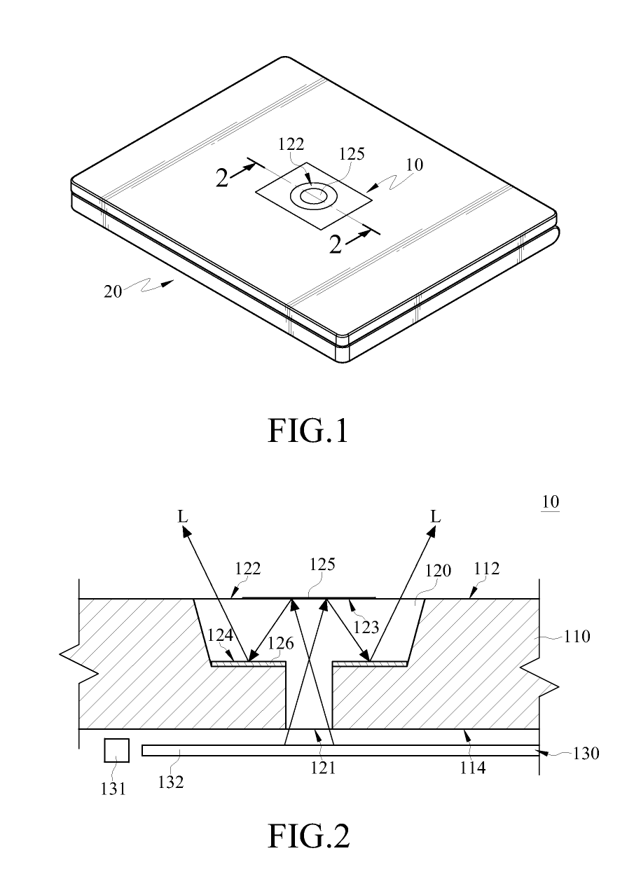

Please refer to FIG. 1 and FIG. 2, FIG. 1 is a schematic view of a light-emitting structure applicable to an electronic device according to an embodiment and FIG. 2 is a cutaway view of a light-emitting structure along line 2-2 in FIG. 1.

A light-emitting structure 10 according to this embodiment is applicable to an illuminating mark on a shell of an electronic device 20, but is not limited to the embodiment. The electronic device 20 may be a laptop computer, but is not limited to the embodiment. The light-emitting structure 10 comprises a shell 110, a light-transmissive body 120, a light-shading layer 125, a patterned layer 126, and a light-source module 130. In this embodiment, the shell 110 is an upper shell of a display device of the electronic device 20, but is not limited to the embodiment. The material of the shell 110 is a light tight material, i.e., a metal or a non-transmission plastic (such as Carbon Fiber Reinforced Plastic, CFRP). The shell 110 has a top surface 112 and a bottom surface 114 corresponding to each other.

The light-transmissive body 120 is embedded in the shell 110. The material of the light-transmissive body 120 is a light transmissive or transparent plastic material, i.e., polycarbonate (PC). The light-transmissive body 120 and the shell 110 are connected to each other in an insert-molding way. Furthermore, in some embodiments, the light-transmissive body 120 is embedded from an outer part of the shell 110 into the shell 110 in a press-fitting way.

Moreover, the shape of the light-transmissive body 120 is about a T-shape column, but the shape of the light-transmissive body 120 is not limited to the embodiment. The light-transmissive body 120 comprises an incident surface 121, an emergence surface 122, a first reflective surface 123 and a second reflective surface 124. In this embodiment, the incident surface 121 of the light-transmissive body 120 and the bottom surface 114 of the shell 110 may be coplanar with each other. The emergence surface 122 of the light-transmissive body 120 and the top surface 112 of the shell 110 may be coplanar with each other. The second reflective surface 124 is positioned between the top surface 112 and the bottom surface 114. In addition, in this embodiment, the first reflective surface 123 may be a flat plane, and the first reflective surface 123 and the emergence surface 122 may be coplanar with each other as well, but not limited to the embodiment.

The light-shading layer 125 is adhered on the first reflective surface 123. The light-shading layer 125 is disposed on the first reflective surface 123 in a printing way or in a sticking way. The shape of the light-shading layer 125 is about a round. Besides, the light-shading layer 125 is surrounded by the emergence surface 122 so that the shape of the emergence surface 122 is about a ring, as shown in FIG. 1. Moreover, the emergence surface 122 in this embodiment is the area that the illuminating brand mark is eager to illuminate. Therefore, the shape of the emergence surface 122 is not limited to the embodiment and the shape of the emergence surface 122 is properly adjusted according to each brand mark of firms.

The patterned layer 126 is adhered on the second reflective surface 124 and revealed at the emergence surface 122. The patterned layer 126 is additionally formed on the second reflective surface 124 in the printing way or in the sticking way. Furthermore, in some embodiments, the patterned layer 126 may directly be a portion of a surface of the shell 110, i.e., a treated surface layer of the shell 110.

The light-source module 130 is disposed in the vicinity of the incident surface 121. In this embodiment, the light-source module 130 comprises an emitting component 131 and a light-guiding plate 132. The light-guiding plate 132 faces the incident surface 121 of the light-transmissive body 120. The emitting component 131 is disposed on an edge of the light-guiding plate 132. In detail, the light-source module 130 in the embodiment guides light emitted from the emitting component 131 to the incident surface 121 of the light-transmissive body 120 by the light-guiding plate 132. Moreover, the light-source module 130 in the embodiment may be a backlight module of a display of the electronic device 20, that is, the display of the electronic device 20 and the light-emitting structure 10 in the embodiment may share the same light source. Furthermore, in some embodiments, the light-emitting structure 10 may have the light-source module 130 alone and may not share the same light source with the display of the electronic device 20.

When the light-source module 130 emits light L, the light L enters the light-transmissive body 120 from the incident surface 121. Then, the light L illuminates the first reflective surface 123 and is reflected to the second reflective surface 124 from the first reflective surface 123. After that, the light L is reflected again to the emergence surface 122 from the second reflective surface 124, and then emits out of the light-transmissive body 120. In this way, the emergence surface 122 may present an illuminating effect, so the electronic device 20 may have the ring shape of the illuminating mark.

At the same time, the patterned layer 126 may be revealed at the emergence surface 122, so while the emergence surface 122 is illuminated, a pattern of the patterned layer 126 may be revealed at the emergence surface 122 simultaneously (when the patterned layer 126 is the portion of the surface of the shell 110, a surface texture of the shell 110 may be revealed through the emergence surface 122), thereby, presenting a three-dimensional stereoscopic visual effect of the illuminating mark.

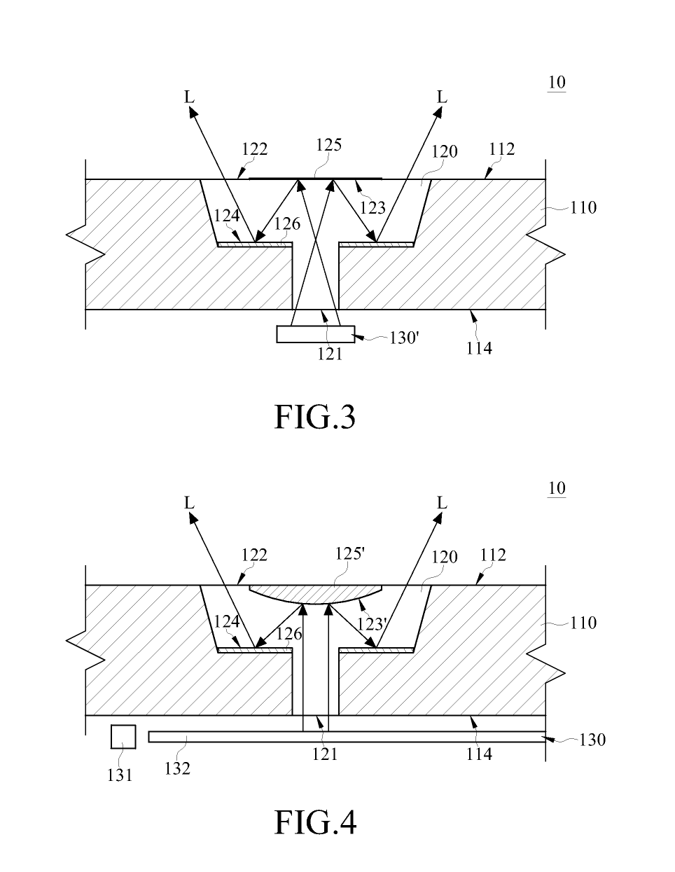

Please refer to FIG. 3, which is a cutaway view of a light-emitting structure according to another embodiment. This embodiment is substantially the same as that in the first embodiment, so the similar parts will not be repeated herein. The difference between this embodiment and the first embodiment is that the light-source module 130′ only comprises one emitting component facing the incident surface 121 directly.

Please refer to FIG. 4, which is a cutaway view of a light-emitting structure according to another embodiment. This embodiment is substantially the same as that in the first embodiment, so the similar parts will not be repeated herein. The difference between this embodiment and the first embodiment is that the first reflective surface 123′ is a curved surface, so the first reflective surface has a wider reflection area, thereby, enhancing a reflection effect of the light L. In addition, the light-shading layer 125′ is embedded in the light-transmissive body 120 in the sticking way or in the press-fitting way and adhered on the first reflective surface 123′.

The above-mentioned embodiment discloses the light-emitting structure. Because of the reveal of the patterned layer by the emergence layer and two times of the reflections of the light, the texture and pattern of the patterned layer may be revealed while the emergence layer is illuminated, thereby, achieving the three-dimensional stereoscopic visual effect of the illuminated mark.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A light-emitting structure, comprising:
a shell;
a light-transmissive body, embedded in the shell, the light-transmissive body comprising an incident surface, an emergence surface, a first reflective surface and a second reflective surface;
a light-shading layer, adhered on the first reflective surface;
a patterned layer, adhered on the second reflective surface, wherein the patterned layer is revealed at the emergence surface; and
a light-source module, disposed in the vicinity of the incident surface, when the light-source module emits light, the light enters the light-transmissive body from the incident surface, the light is reflected to the second reflective surface from the first reflective surface, then the light is reflected to the emergence surface from the second reflective surface before emits out of the light-transmissive body.

2. The light-emitting structure according to claim 1, wherein the shell has a top surface and a bottom surface, the top surface and the bottom surface corresponds to each other, the incident surface and the bottom surface are coplanar with each other, the emergence surface and the top surface are coplanar with each other, and the second reflective surface is positioned between the top surface and the bottom surface.

3. The light-emitting structure according to claim 1, wherein the patterned layer is a portion of a surface of the shell.

4. The light-emitting structure according to claim 1, wherein the first reflective surface is a flat plane.

5. The light-emitting structure according to claim 1, wherein the first reflective surface is a curved surface.

6. The light-emitting structure according to claim 1, wherein the light-source module further comprises an emitting component facing the incident surface.

7. The light-emitting structure according to claim 1, wherein the light-source module further comprises an emitting component and a light-guiding plate, the light-guiding plate faces the incident surface, and the emitting component is disposed on an edge of the light-guiding plate.

8. The light-emitting structure according to claim 1, wherein the first reflective surface and the emergence surface are coplanar with each other.

9. The light-emitting structure according to claim 1, wherein the second reflective surface is positioned between the incident surface and the emergence surface.

10. The light-emitting structure according to claim 1, wherein the light-shading layer is surrounded by the emergence surface.
